(19) United States
(12) Patent Application Publication
(10) Pub. No.: US 2021/0337245 A1
(43) Pub. Date: Oct. 28, 2021

(54) SYSTEM AND METHOD FOR VIRTUAL ATTENDANCE OF LIVE EVENT

(71) Applicant: Robert Meitus, Bloomington, IN (US)

(72) Inventor: Robert Meitus, Bloomington, IN (US)

(21) Appl. No.: 17/238,132

(22) Filed: Apr. 22, 2021

Related U.S. Application Data
(60) Provisional application No. 63/013,611, filed on Apr. 22, 2020.

(51) Int. Cl. H04N 21/2187; H04N 21/4788; H04N 21/439; G06Q 10/02

(52) U.S. Cl. CPC H04N 21/2187; G06Q 10/02; H04N 21/439; H04N 21/4788

(57) ABSTRACT

A system for virtual attendance of a live event includes an electronic media system broadcasting the live event from an event venue. A software platform facilitates receipt of the broadcasting at a first user device of a first virtual attendee and a second user device of a second virtual attendee. The software platform facilitates direct communication between the first virtual attendee and the second virtual attendee during the live streaming of the live event.

### CROSS-REFERENCE TO RELATED APPLICATION

The present application is related to and claims the priority benefit of U.S. Provisional Patent Application No. 63/013,611, filed on Apr. 22, 2020, the entire contents of which are incorporated herein by reference.

### TECHNICAL FIELD

This specification relates to the field of software. More specifically, the present technology is in the technical field of software-based digital systems for virtual attendance of a live event.

### BACKGROUND

The current COVID-19 pandemic has reminded us that social distancing and mandatory stay-at-home quarantine responses are the primary response to slow the spread of disease during pandemic outbreaks. While we all hope that the current COVID-19 outbreak quickly runs its course, it would be foolish to imagine that there will never be another pandemic. During such social distancing situations, people are feeling acute and unmet needs for social interactions and shared artistic experiences, such as concerts. There are currently no options to experience live local music in a high quality and shared social setting absent the traditional, in-person concert experience. Thus, there is a need for a high-quality live-music experience that may be enjoyed while adhering to social distancing guidelines. The present novel technology addresses this need and also provides an online tool for “local” concert experiences even outside of a pandemic.

### SUMMARY

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an exemplary system architecture for an embodiment of the present disclosure;

FIG. 2 depicts a high level diagram identifying basic functionality of the system and method described herein, according to an aspect of the present disclosure;

FIG. 3 depicts a flow diagram illustrating a user experience provided by the system and method described herein, according to another aspect of the present disclosure;

FIG. 4 depicts a flow diagram illustrating a watch party feature of the present disclosure, according to another aspect of the present disclosure;

FIG. 5 depicts an exemplary watch page of the system and method described herein, according to another aspect of the present disclosure; and

FIG. 6 illustrates a user interface for participating in an organized meeting with a performer or artist, according to another aspect of the present disclosure.

Like reference numbers and designations in the various drawings indicate like element.

### DETAILED DESCRIPTION

Before the present methods, implementations, and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not. Additionally, “generates,” “populates,” “generating,” and “populating” mean that the system or module may produce some event or cause some event element to be produced. For example, a webpage may receive data to display in whole or in part to display a valuation estimate to an end user device, the webpage may pull such data from a source other than system (e.g., other servers, intermediaries, etc.), or system may entirely provide the valuation estimate to be produced on the webpage.

“Click,” “touch,” and “tap” are terms that typically may be used interchangeably. For example, on a mobile device, users typically touch or tap the screen to select items or press buttons. On a laptop, smartphone, and/or desktop users typically click with a mouse but may in some implementations use a touchscreen or the like interface.

The present disclosure provides users an opportunity to view and participate in a live event from a virtual location. Among other features, the present disclosure facilitates direct communication between two or more virtual attendees of the live event before, during and after the live event. An exemplary system and method according to the present disclosure is provided below; however, the example provided in no way limits the present disclosure.

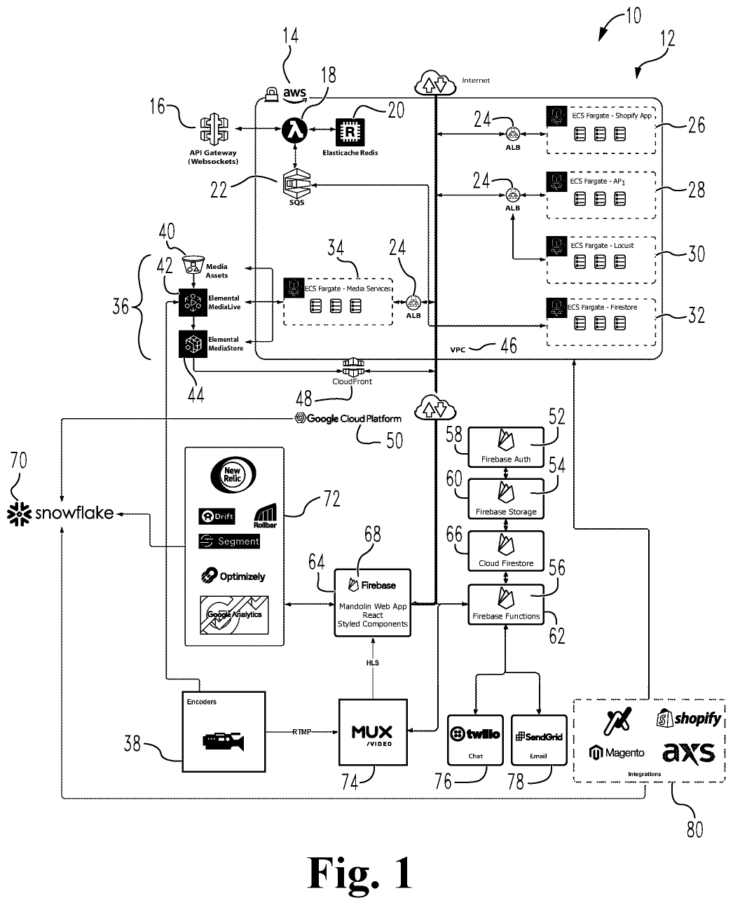

FIG. 1 is a diagram 10 of an architecture 12 of an exemplary embodiment of the present disclosure. According to the exemplary embodiment, the architecture 12 may include a cloud computing platform 14, such as, for example, an Amazon Web Services (AWS) platform offered by Amazon, or, more particularly, may include a cloud video streaming platform. Although a particular embodiment is depicted and/or described, it should be appreciated that the system and method of the present disclosure are not thereby limited.

An API gateway 16 may include a collection of web sockets and may provide bi-directional communications between clients and backend services. AWS Lambda 18 is a service, offered by Amazon, that lets you run code without provisioning or managing servers. It facilitates the building of serverless applications composed of functions that are triggered by events, and automatically deploys them using the AWS platform. The architecture may also include Elasticache Redis 20, for example, for providing a fast in-memory data store.

Simple Queue Service (SQS) 22 may be utilized and may function as a distributed message and queueing service. The architecture 12 may also use Fargate serverless computer engines for containers that work with AWS Elastic Container Service (ECS) and AWS Elastic Kubernetes Service (EKS). This may include various modules or apps which may be administered using load balancers 24. Fargate may be used for creating mobile and web apps. Modules may include, and are not limited to, a Shopify App 26, for example, APIs 28, Locust 30, Firestore forwarder 32 and media services 34. As shown, SQS may communicate with the Firestone forwarder.

The architecture also facilitates live streaming with one or more media tools 36 in communication with a source of live streaming, shown, for example, at 38. Live video processing tools may include Media Assets 40, elemental MediaLive 42, Elemental MediaStore 44, and the media services component of Fargate 34. This electronic media system 36 may provide live streaming of a live event from the event venue, where receipt of the live streaming may be at one or more electronic devices of one or more users or virtual attendees of the live event.

The components and features discussed thus far may operate in a virtual private cloud (VPC) 46, which is a service that lets you launch AWS resources in a logically isolated virtual network that you define. The system and method disclosed herein may also include a content delivery network 48, such as Amazon CloudFront, that may be used as a web service that speeds up distribution of web content to users.

The system and method described herein may also include Google's mobile development platform 50 for tasks such as authentication (52), storage (54), and various functions (56). Firebase, examples of which are at 58, 60, 62 and 64, is a platform developed by Google for creating mobile and web applications. As shown, the system and method may also use Cloud Firestore 66, which is a document database. And, React 68, which is a library created for building fast and interactive user interfaces for web and mobile applications, may also be used. Snowflake 70 is a cloud based data warehousing that may also be included in the architecture.

The systems, components, and features of FIG. 1 are provided for exemplary purposes only and do not in any way limit the disclosed system and method of the present disclosure. In addition to variances in composition and functionality, the system and method of the present disclosure may include or integrate various tools, apps and/or functionality from 3^{rd} parties, as shown at 72, 74, 76, 78, and 80. According to one embodiment, the present disclosure may utilize MUX video 74 as an electronic media system for live streaming.

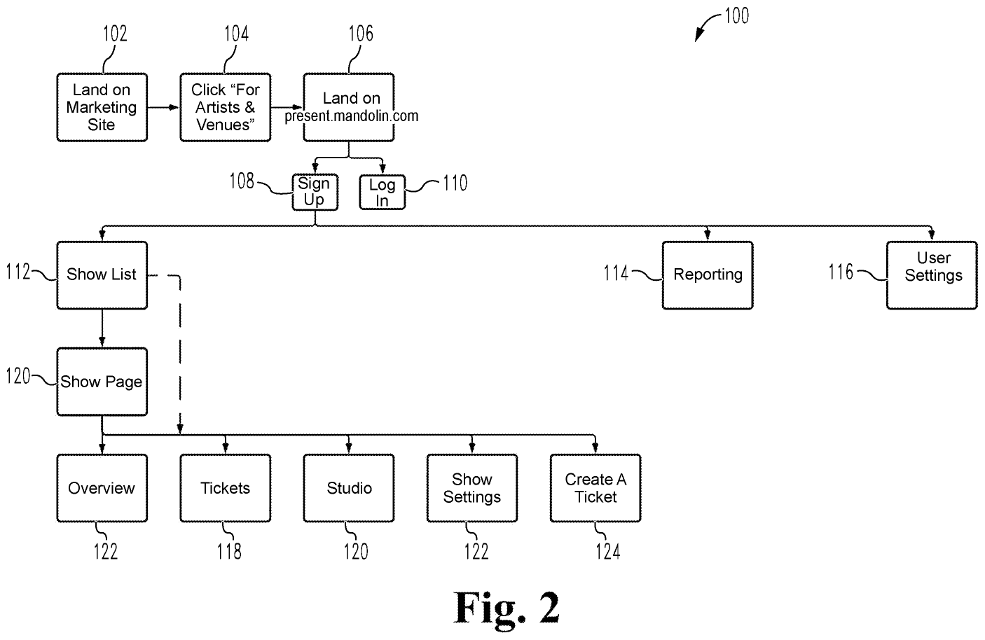

FIG. 2 depicts a high level diagram 100 identifying basic functionality of the system and method described herein. A user may first be directed to or land on a marketing site, at 102, which may promote one or more products and/or services of one or more different businesses and may thereafter click on “For Artists & Venues,” at 104. Eventually, the user may land on a hosted website 106, such as one configured to provide the functionality described herein. A user may be provided options at the website 106 of signing up 108 or logging in 110. After being logged in, a user may have options of viewing a list of events 112, reporting 114, and viewing and/or adjusting user settings 116.

From the list of events, at 116, the user may be able to advance to ticketing 118, or may advance to the viewing of a page, at 120, relevant to the page selected at 112, and/or an overview of the selected event, at 122. Functionality at 120, 122, and 124 may be provided in the process of creating a ticket to a specific live event, as selected by the user.

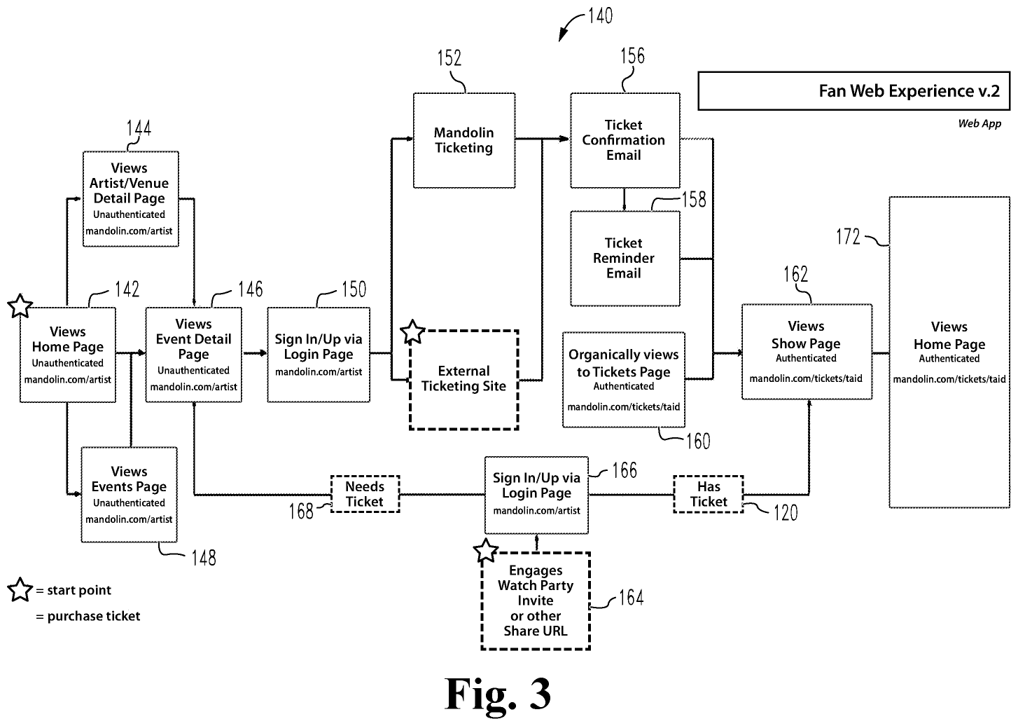

FIG. 3 depicts a flow diagram 140 illustrating a user experience provided by the system and method of the present disclosure. A user views the home page 142 and may advance to a view artist/venue details page 144, event details page 146, or views events page 148. From the event details page 146, a user may proceed to sign up/log in, at 150, and then advance to at least one ticketing site 152 or 154. The user may receive a ticket confirmation email, at 156 and a ticket reminder email, at 158. The user may thereafter progress to the tickets page 160 and then the show page 162.

If the user is invited to the event, such as with regard to a watch party or other shared URL, at 164, the user may advance to an opportunity to sign in or sign up at a login page 166. If the user needs a ticket, at 168, the user is directed to the event details page at 146. If the user already has a ticket, at 170, the user proceeds to the show page, at 162. Eventually, the user may be directed to the home page 172.

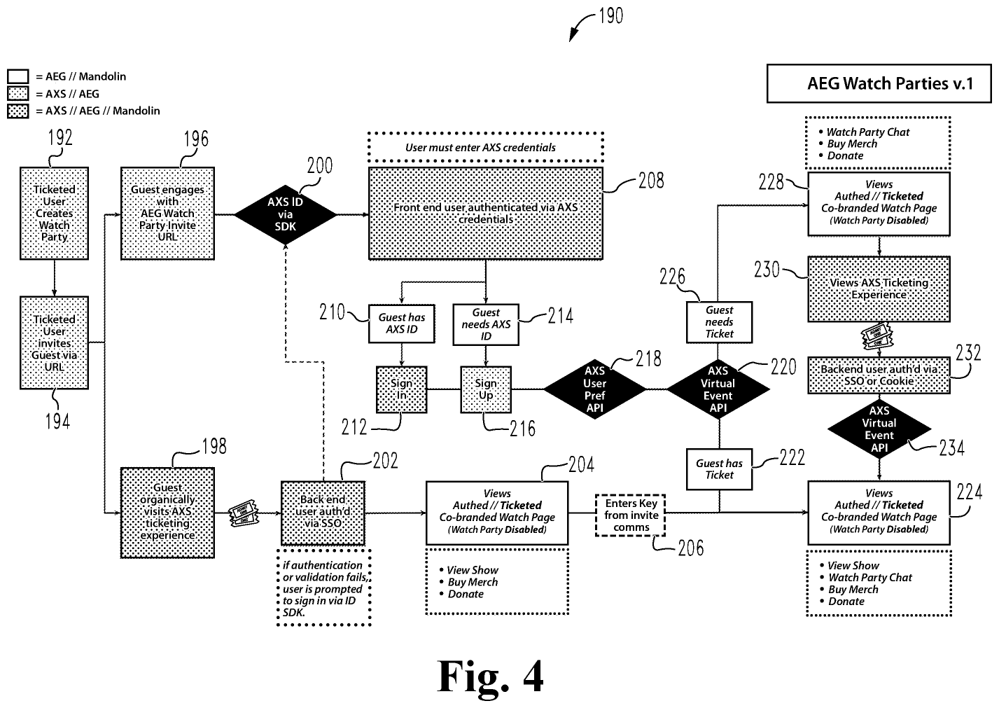

FIG. 4 depicts a flow diagram 190 illustrating a watch party feature of the present disclosure. For example, a ticketed user may create a watch party for a specific live event, at 192. At 194, the user may invite guests to the watch party via a URL. The user then proceeds to ticketing options at 196 or 198. At 196, the user engages with AEG, a ticket service provider, where the user may be authenticated at 200. From 198, the user, having organically visited the AXS site, may be authenticated via SSO. If authentication fails, the user may be directed to 200 to be authenticated with AXS credentials via SDK.

If the user is authenticated at 202, the user may proceed to the views page, with the watch party disabled, 204. The user may be given options of viewing the show, buying merchandise and/or donating to a cause. When proceeding, the user is prompted to enter a key from the invite communication, at 206.

Returning to the authentication options at 196 and 200, the user may be authenticated at 208 via AXS credentials. If the user has an AXS ID (210), the user proceeds to a sign in page, at 212. If the user needs an AXS ID (214), the user proceeds to a sign up page, at 216. Afterwards, the user advances through the AXS user preferences API 218 and the AXS virtual event API 220.

If the user has a ticket, at 222, the user may be directed to the views/authenticated/ticketed/co-branded page, at 224, with watch party enabled. Among other functionality, the user may have options to view the show, watch party chat, buy merchandise, and/or donate. If the user needs a ticket, at 226, the user may be directed to an unticketed watch page, at 228, with the watch party enabled. The user is next directed to the AXS ticketing site, at 230, and may be authenticated via SSO or Cookie, at 232.

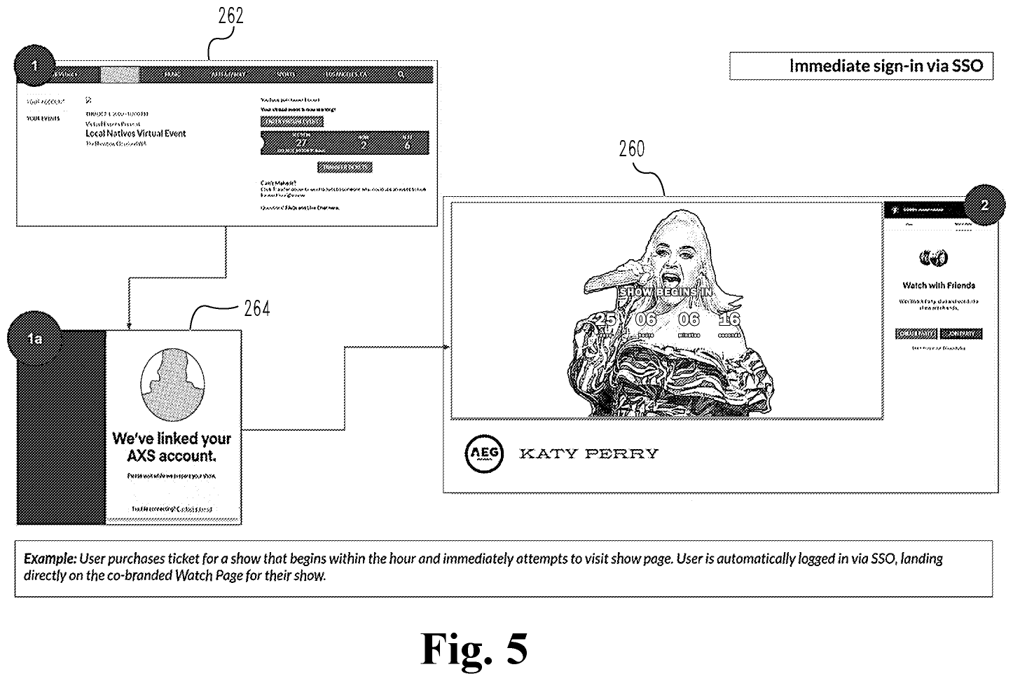

FIG. 5 depicts an exemplary watch page 260 of the system and method described herein. The user may purchase a ticket, at 262. The user may then be authenticated at 264, and, if within a predetermined time until the show begins, the user will land directly on the co-branded watch page 260 for the show.

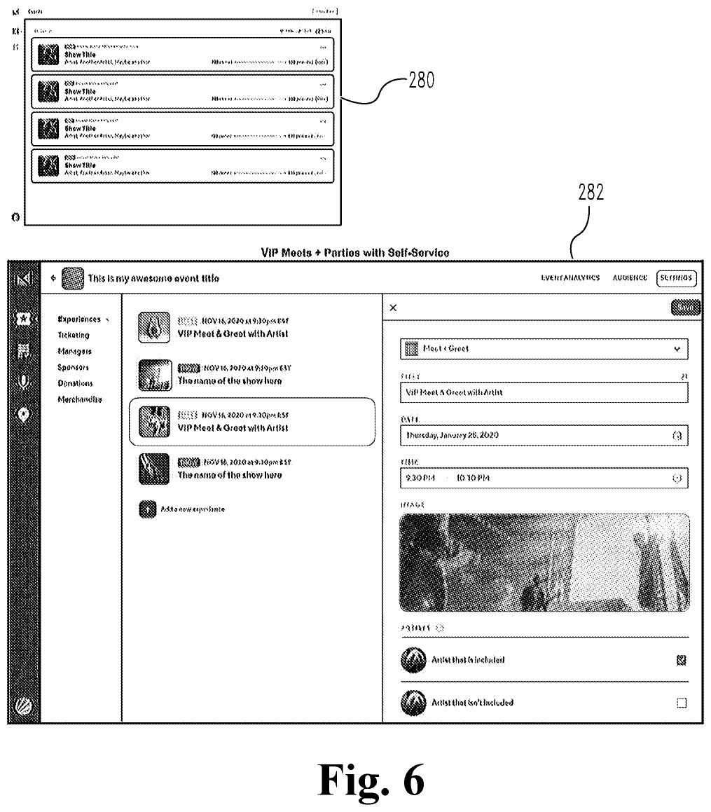

FIG. 6 illustrates a user interface for participating in an organized meeting with a performer, according to another aspect of the present disclosure. A list of upcoming shows may be viewed at 280. After selecting one of the shows at 280, the user may be directed to the page at 282 for viewing and selection of an opportunity for a meet and greet with the artist/performer.

Additional features may include un-muted feedback during an event. For example, one or more users may be un-muted to clap or otherwise provide a reaction during the live event. This adds to the look, sound and feel of a live concert from a virtual location.

In addition, the system of the present disclosure may utilize co-branding in which two or more businesses and/or brands may come together to provide features for the system.

Further, the system may integrate non-fungible tokens, which are a units of data stored on a digital ledger, called a blockchain, that certifies a digital asset to be unique and therefore non interchangeable. Non-fungible tokens and not interchangeable. Non-fungible tokens can be used to represent items such as photos, videos, audio and other types of digital files.

The system may be implemented using a variety of different digital environments and should not be limited to the exemplary embodiment that is provided. For example, the system may be a web based application or may be a cloud based application. Further, major components of a digital environment may include websites, cloud servers, search engines, social media outlets, mobile apps, audio and video, and other web-based resources, to name a few. The system may also include load balancing, application fire walling, and various other components for improving operation and security of the system.

Various users, using any one of a variety of different user devices, may access the system as described herein, such as, for example, via the Internet. Exemplary user devices may include desktop computers, mobile phones, tablets, smart TVs, etc. A variety of different users may use the system with respect to any of a variety of different functionalities and/or services offered by the system.

The one or more databases may be used to store a variety of information needed for operating the system, including, for example, user accounts and profiles, profile settings, user preferences, and various information about events and event venues, and various other information that may or may not be unique to the system for virtual seating and distance measurement. Types of information that may be stored may include images, text, media files, etc. The system may also include management, security and services.

1. A system for virtual attendance of a live event, including:
an electronic media system live streaming the live event from an event venue;
a software platform facilitating receipt of the live streaming at a first user device of a first virtual attendee and a second user device of a second virtual attendee; and
the software platform facilitating direct communication between the first virtual attendee and the second virtual attendee during the live streaming of the live event.

2. The system of claim 1, wherein the electronic media system is an audiovisual system.

3. The system of claim 1, wherein the software platform facilitates private communication between the first virtual attendee and the second virtual attendee.

4. The system of claim 1, wherein the software platform facilitates communication among a group of virtual attendees.

5. The system of claim 1, wherein the audiovisual system is live streaming the live event from a perspective of a virtual position of the first virtual attendee relative to the venue.

6. The system of claim 1, wherein virtual attendance is limited to a predetermined number of virtual attendees.

7. The system of claim 1, wherein virtual attendance of the live event is limited by a size of the event venue.

8. The system of clam 1, wherein the first virtual attendee provides unmuted feedback during the live event.

9. The system of claim 1, wherein the first virtual attendee pays a predetermined fee online for virtual attendance of the live event.

10. The system of claim 1, wherein the software platform facilitates purchase of event merchandise.

11. The system of claim 1, wherein the software platform facilitates communication between one or more virtual attendees and one or more participants of the live event.

12. A method for virtual attendance of a live event, including:
live streaming the live event from an event venue using an electronic media system;
receiving the live streaming at a first user device of a first virtual attendee and a second user device of a second virtual attendee using a software platform; and
facilitating direct communication between the first virtual attendee and a second virtual attendee during the live streaming of the live event using the software platform.

13. The method of claim 12, further including facilitating private
communication between the first virtual attendee and the second virtual using the software platform.

14. The method of claim 12, further including facilitating communication among a group of virtual attendees using the software platform.

15. The method of claim 12, further including live streaming the live event from a perspective of a virtual position of the first virtual attendee relative to the event venue.

16. The method of claim 12, further including limiting virtual attendance to a predetermined number of virtual attendees.

17. The method of claim 12, further including limiting virtual attendance to a capacity of the event venue.

18. The method of clam 12, further including providing the first virtual attendee unmuted feedback during the live event.

19. The method of claim 12, further including facilitating an online purchase of a ticket for the live event by the first virtual attendee for virtual attendance of the live event

20. The method of claim 12, further including facilitating communication between one or more virtual attendees and one or more participants of the live event.
